(19) United States
(12) Patent Application Publication
(10) Pub. No.: US 2026/0157547 A1
(43) Pub. Date: Jun. 11, 2026

(54) FREESTANDING MIRROR ASSEMBLY

(71) Applicant: Kelli Richard, Fayetteville, GA (US)

(72) Inventor: Kelli Richard, Fayetteville, GA (US)

(21) Appl. No.: 18/969,570

(22) Filed: Dec. 5, 2024

(51) Int. Cl. A47G 1/04; F16M 11/14

(52) U.S. Cl. CPC A47G 1/04; F16M 11/14

(57) ABSTRACT

A freestanding mirror assembly includes an elongated mirror and a stand. The elongated mirror is divided into sections that include a center section, a left section pivotably connected to a left side of the center section, and a right section pivotably connected to a right side of the center section. Each of the left section and the right section is pivotable to permit a user to selectively adjust an angular position each of the left section and the right section with respect to the center section. The stand is connected to the center section and designed to support said elongated mirror.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention.

The disclosure relates to mirrors and more particularly pertains to a new freestanding mirror assembly to provide users with the ability to see sides and rear portions of their heads and bodies. The elongated mirror is divided into pivotable sections to allow different view angles. In addition, the mirror is rotatable to provide a full-length mirror for viewing an entire body of a user.

### (2) Description of Related Art Including Information Disclosed Under 37 CFR 1.97 and 1.98

The prior art relates to mirrors that have adjustable portions. The prior art, as best understood, does not disclose a freestanding mirror assembly that includes an elongated mirror and a stand, wherein the mirror is divided into three sections that are pivotably connected, one on either side of a center section. In addition, the elongated mirror is rotatably connected to the stand to permit a user to rotate and selectively adjust an orientation of the elongated mirror from a horizontal position to a vertical position and vice versa.

### (H) BRIEF SUMMARY OF THE INVENTION

An embodiment of the disclosure meets the needs presented above in a freestanding mirror assembly generally comprising an elongated mirror and a stand. The elongated mirror is divided into sections that include a center section, a left section pivotably connected to a left side of the center section, and a right section pivotably connected to a right side of the center section. Each of the left section and the right section is pivotable to permit a user to selectively adjust an angular position each of the left section and the right section with respect to the center section. The stand is connected to the center section and designed to support said elongated mirror.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a freestanding mirror assembly according to an embodiment of the disclosure.

FIG. 2 is a perspective view of an embodiment of the disclosure.

FIG. 3 is a perspective view of an embodiment of the disclosure.

FIG. 4 is a close up rear view of an embodiment of the disclosure.

FIG. 5 is a rear view of an embodiment of the disclosure.

FIG. 6 is a rear view of an embodiment of the disclosure.

FIG. 7 is a side cross-sectional view of an embodiment of the disclosure shown in FIG. 5.

FIG. 8 is a top view of an embodiment of the disclosure.

FIG. 9 is a top view of an embodiment of the disclosure.

### (J) DETAILED DESCRIPTION OF THE INVENTION

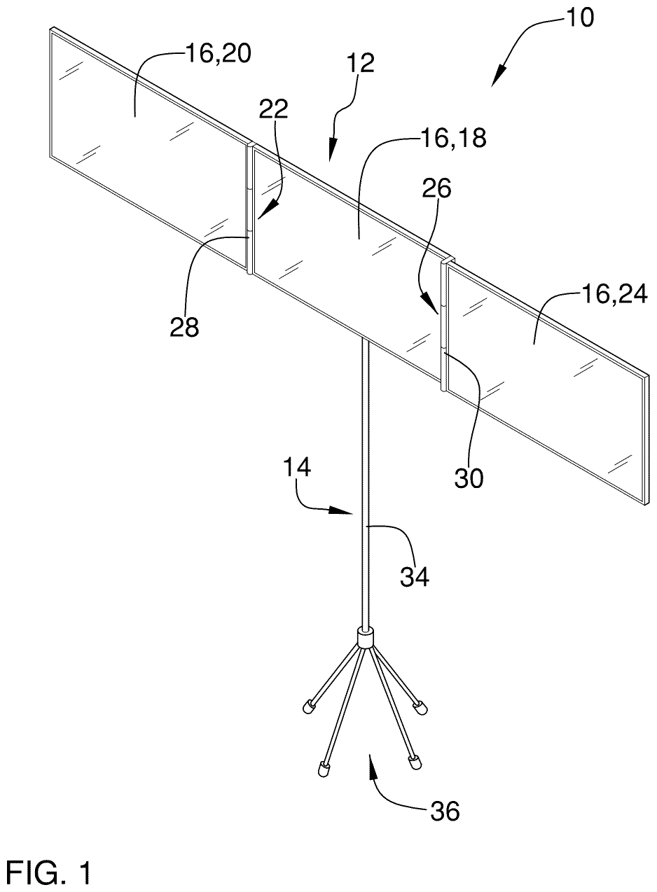

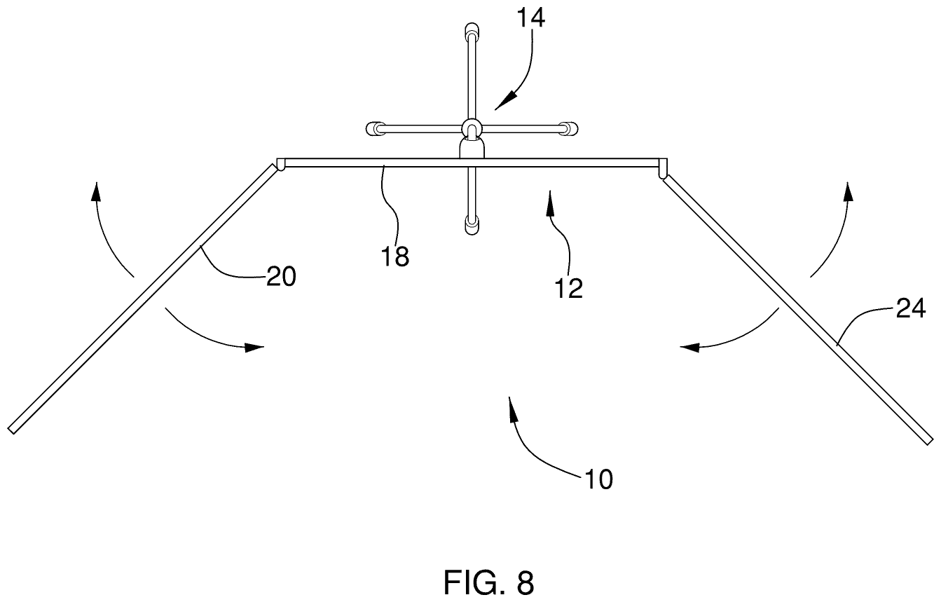

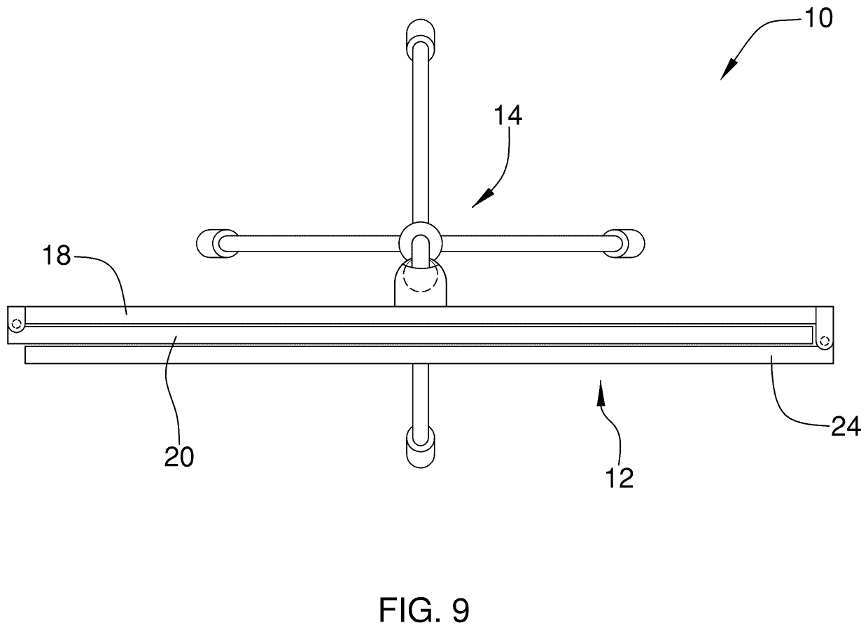

With reference now to the drawings, and in particular to FIGS. 1 through 9 thereof, a new freestanding mirror assembly embodying the principles and concepts of an embodiment of the disclosure and generally designated by the reference numeral 10 will be described.

As best illustrated in FIGS. 1 through 9, the freestanding mirror assembly 10 generally comprises an elongated mirror 12 and a stand 14. The elongated mirror 12 is divided into sections 16 that include a center section 18, a left section 20 pivotably connected to a left side 22 of the center section 18, and a right section 24 pivotably connected to a right side 26 of the center section 18. Each of the left section 20 and the right section 24 is pivotable to permit a user to selectively adjust an angular position each of the left section 20 and the right section 24 with respect to the center section 18. The stand 14 is connected to the center section 18 and designed to support said elongated mirror 12.

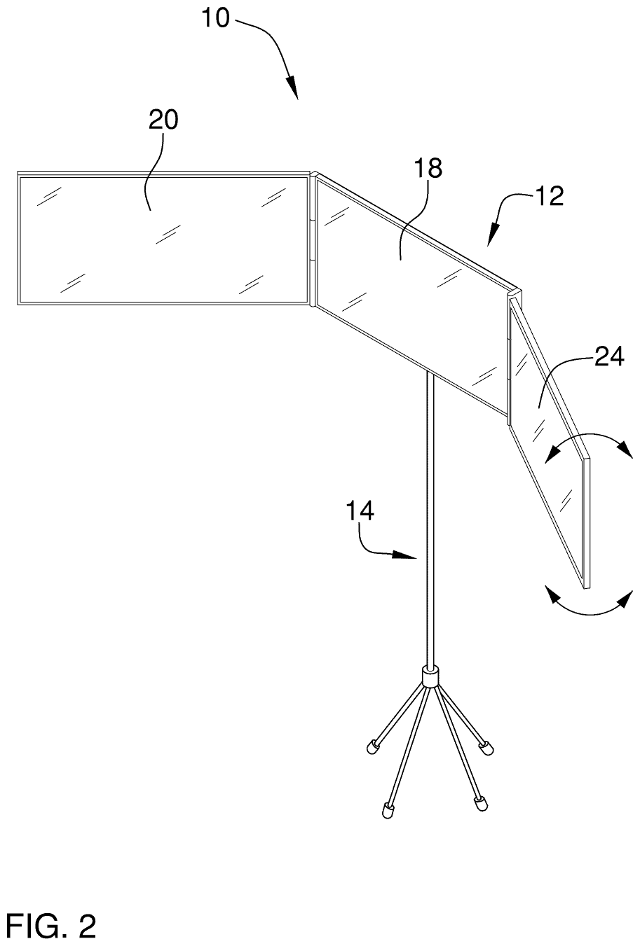

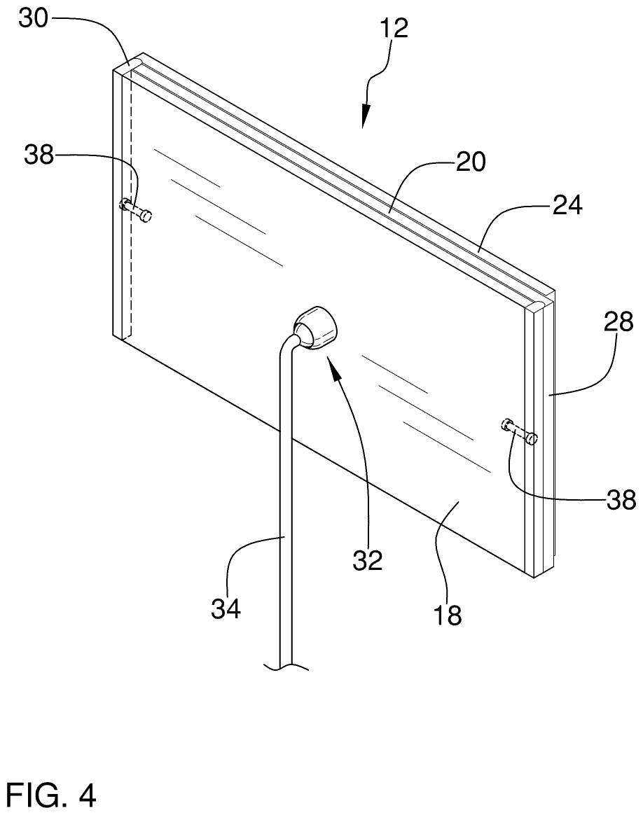

In FIG. 1, the sections 16 are aligned to form an essentially flat or planar mirror. The center section 18 is pivotably connected to the left section 20 by a left hinge 28, and the center section 18 is pivotably connected to the right section 24 by a right hinge 30. As shown in FIG. 2, this hinged connection permits the angular adjustment as shown. A user is free to adjust the left section 20 and the right section 24 to essentially any angle with respect to the center section 18 over about a 180-degree range of movement. As shown in FIG. 4, the left section 20 and the right section 24 are foldable over the center section 18 in a stacked manner. In the exemplary embodiment shown, the hinge of the left section 20 is somewhat extended to allow folding over the right section 24. Each of the sections 16 is rectangular, though other shapes, such as square, are within the scope of the disclosure.

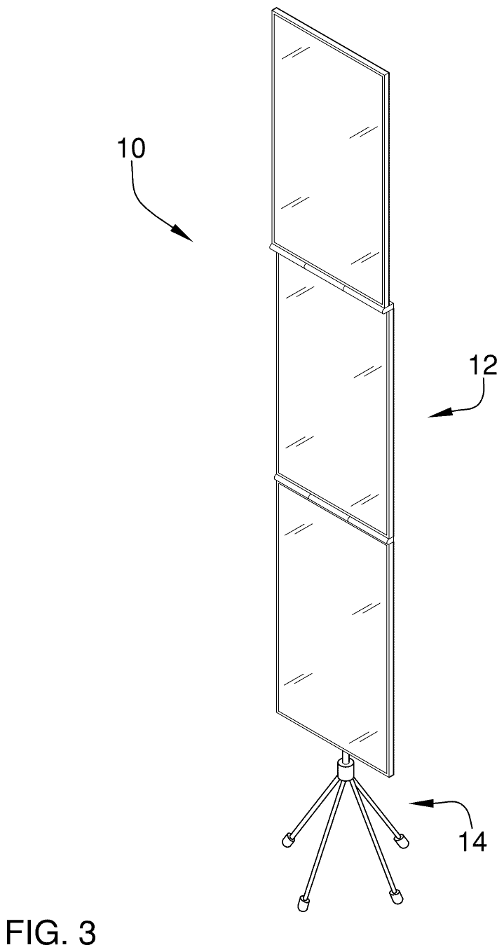

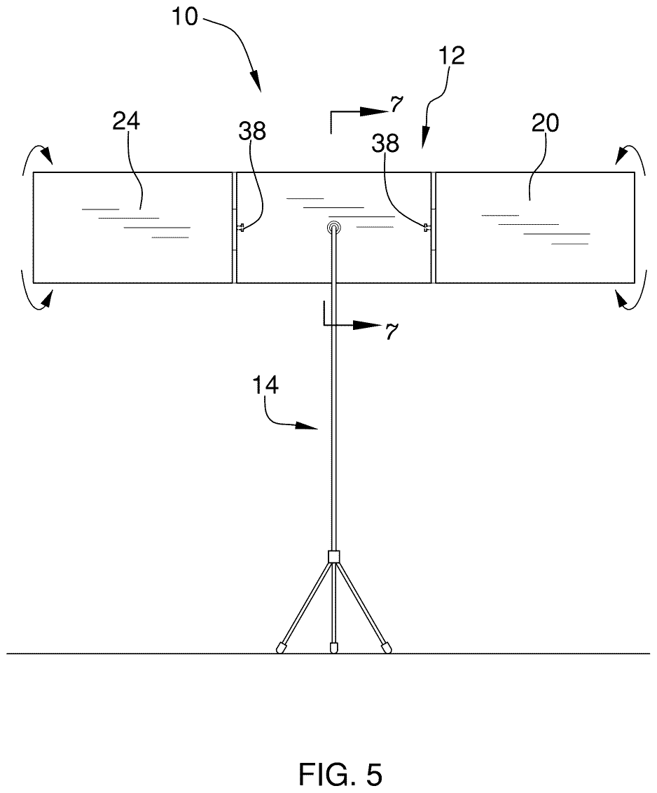

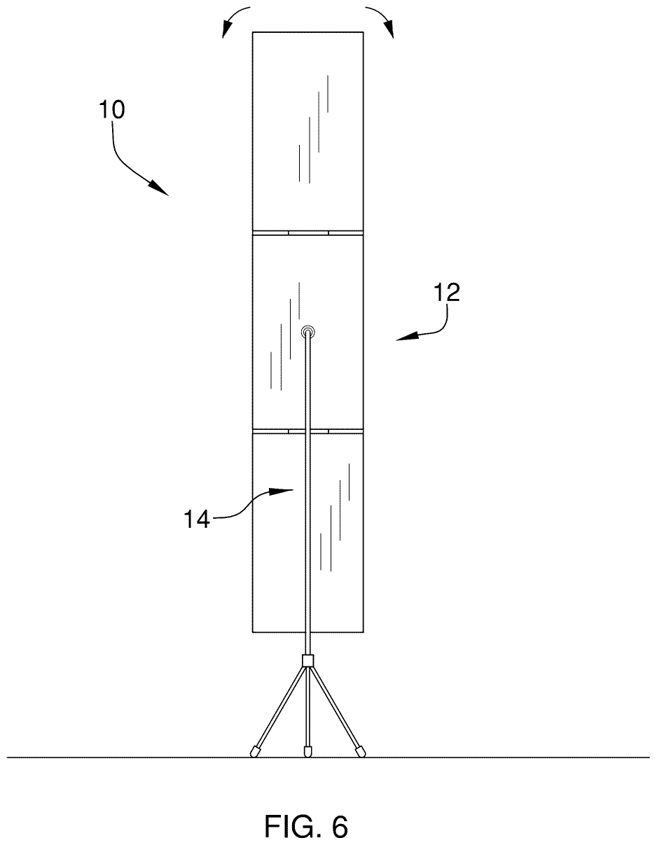

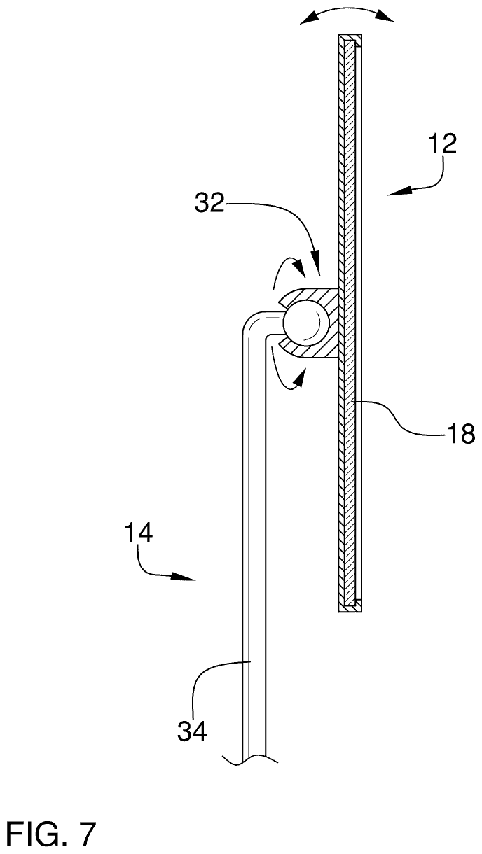

As shown in FIGS. 5 and 6, the center section 18 is rotatably connected to the stand 14 to permit a user to rotate the center section 18, and thus the left section 20 and the right section 24 connected thereto, and thereby selectively adjust an orientation of the sections 16 from a horizontal position (FIGS. 1 and 5) to a vertical position (FIGS. 3 and 6) and vice versa. This pivotability allows a user to use the elongated mirror 12 as a facial or upper body mirror and as a full-length or full-body mirror. In the exemplary embodiment shown in FIGS. 4 and 7, the center section 18 and the stand 14 are connected by a ball-and-socket joint 32 to permit a user to selectively rotate and pivot the center section 18 with respect to the stand 14.

In one possible embodiment, each of the sections 16 has a length in a range of about 20 to 26 inches, such that the elongated mirror 12 can be about 60 to 78 inches in length. However, in another possible embodiment, each of the sections 16 could have a length in a range of about 14 to 20 inches, such that the elongated mirror 12 can be about 42 to 60 inches in length. In the exemplary embodiment shown, each of the sections 16 is the same size, though they could be of different sizes. The stand 14 has a height of at least 36 inches. The stand 14 includes a pole 34 and a plurality of feet 36, though other common stand designs are within the scope of the disclosure.

Also as shown in FIGS. 4 and 5, the elongated mirror 12 can include support posts 38, which allow for the left section 20 and the right section 24 to be pivotable about those posts 38, such as 360 degrees.

In use, when the elongated mirror 12 is in the horizontal position, the user can pivot the left section 20 or the right section 24 to a desired angle in order to permit a user to view sides and rear portions of the user's head and body. The user can also pivot the elongated mirror 12 to the vertical position to use as a full-length mirror.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A freestanding mirror assembly comprising:
an elongated mirror divided into sections comprising a center section, a left section pivotably connected to a left side of said center section, and a right section pivotably connected to a right side of said center section, wherein each of said left section and said right section is pivotable to permit a user to selectively adjust an angular position of each of said left section and said right section with respect to said center section; and
a stand connected to said center section and configured to support said elongated mirror.

2. The freestanding mirror assembly of claim 1, wherein said center section is pivotably connected to said left section by a left hinge, and said center section is pivotably connected to said right section by a right hinge.

3. The freestanding mirror assembly of claim 2, wherein said left section and said right section are foldable over said center section in a stacked manner.

4. The freestanding mirror assembly of claim 1, wherein each of said sections is rectangular.

5. The freestanding mirror assembly of claim 1, wherein each of said sections has a length in a range of about 20 to 26 inches.

6. The freestanding mirror assembly of claim 1, wherein each of said sections is the same size.

7. The freestanding mirror assembly of claim 1, wherein said center section is rotatably connected to said stand to permit a user to rotate said center section, and thus said left section and said right section connected thereto, and thereby selectively adjust an orientation of said sections from a horizontal position to a vertical position and vice versa.

8. The freestanding mirror assembly of claim 1, wherein said center section and said stand are connected by a ball-and-socket joint to permit a user to selectively rotate and pivot said center section with respect to said stand.

9. The freestanding mirror assembly of claim 1, wherein said stand has a height of at least 36 inches.

10. The freestanding mirror assembly of claim 1, wherein said stand comprises a pole and a plurality of feet.

11. The freestanding mirror assembly of claim 1, wherein said center section includes a pair of support posts projecting out from a respective one of said left side and said right side, and each of said left section and said right section is connected to said center section by said support posts and rotatable about said support posts.

12. The freestanding mirror assembly of claim 1, wherein:
said center section is pivotably connected to said left section by a left hinge, and said center section is pivotably connected to said right section by a right hinge;
said left section and said right section are foldable over said center section in a stacked manner;
each of said sections is rectangular;
said center section is rotatably connected to said stand to permit a user to rotate said center section, and thus said left section and said right section connected thereto, and thereby selectively adjust an orientation of said sections from a horizontal position to a vertical position and vice versa;
said center section and said stand are connected by a ball-and-socket joint to permit a user to selectively rotate and pivot said center section with respect to said stand; and
said center section includes a pair of support posts projecting out from a respective one of said left side and said right side, and each of said left section and said right section is connected to said center section by said support posts and rotatable about said support posts.

13. The freestanding mirror assembly of claim 12, wherein:
each of said sections has a length in a range of about 20 to 26 inches;
each of said sections is the same size;
said stand has a height of at least 36 inches; and
said stand comprises a pole and a plurality of feet.
